(19) United States
(12) Patent Application Publication
(10) Pub. No.: US 2022/0344064 A1
(43) Pub. Date: Oct. 27, 2022

(54) High-burnup Fast Reactor Metal Fuel

(71) Applicants: Di Yun, Xian City (CN); Chunyang Wen, Xian City (CN); Linna Feng, Xian City (CN); Zhaohao Wang, Xian City (CN); Wenbo Liu, Xian City (CN); Jianqiang Shan, Xian City (CN)

(72) Inventors: Di Yun, Xian City (CN); Chunyang Wen, Xian City (CN); Linna Feng, Xian City (CN); Zhaohao Wang, Xian City (CN); Wenbo Liu, Xian City (CN); Jianqiang Shan, Xian City (CN)

(21) Appl. No.: 17/336,291

(22) Filed: Jun. 1, 2021

(30) Foreign Application Priority Data
Apr. 23, 2021 (CN) 202110463323.4

(51) Int. Cl. G21C 1/02

(52) U.S. Cl. CPC G21C 1/02

(57) ABSTRACT

The disclosure discloses a high-burnup fast reactor metal fuel, wherein the reactor core is loaded with metal fuel made of natural uranium alloy U-50Zr. The metal fuel manually controls the temperature to realize phase transition, increase burnup, and extend the service life of fuel; increases the fuel burnup to increase uranium utilization and reduce the pressure of disposing nuclear waste; extends the fuel life cycle to reduce nuclear power costs and improve the economy of nuclear energy; effectively carries out the timely release of fission gas and the periodic elimination of fuel defects, thus reducing the fuel-cladding mechanical interaction caused by swelling, and increasing the safety.

### TECHNICAL FIELD

The disclosure relates to the field of nuclear reactor fuel technology, in particular to a high-burnup fast reactor metal fuel.

### BACKGROUND

As a concept of reactor design, the fast reactor loaded with high-burnup metal fuel is mainly proposed to improve the inherent safety and economy of the reactor. It belongs to the scope of fast reactor and meets the technical requirements and safety standards of fourth-generation nuclear energy. The basic operating principle of the reactor design is that the neutrons transform the fissionable nuclides into the fissile nuclides, which start to burn under the impact of the neutrons. The reactor concept includes a traveling wave reactor, which continuously converts the fissionable fuel element (U-238) into a new fissile fuel element (Pu-239) after being first ignited by enriched uranium fuel, thus allowing the diffusion of breeding combustion wave. Self-breeding of reactor core significantly reduces the need for enrichment and reprocessing of uranium.

Taking the traveling wave reactor as an example, its fuel mainly comes from spent fuel and depleted uranium or natural uranium. The refueling cycle is long, and the utilization rate of uranium resources can reach 70%. It has the advantages of efficient use of uranium resources and reduced discharge of spent fuel. The widespread use of fast breeder reactors (typical examples include traveling wave reactors) will transform spent fuel into precious utilizable resources while reducing dependence on enriched uranium. The spent fuel unloaded from high-burnup fast breeder reactors does not need to be reprocessed. A large number of long-lived radionuclides transmute into light-core and short-lived radionuclides during the combustion of fast breeder reactors, thus effectively reducing the long-term radioactive risks of spent fuel. This fast reactor can realize no refueling for decades, and one fueling can meet the power generation demand for decades. This also reflects the core advantages of fast reactor loaded with high-burnup metal fuel. Despite the good development prospect, fast reactor loaded with high-burnup metal fuel still faces many problems to be addressed. One of the problems is the service performance of the fuel.

At present, the core fuel design for fast reactor loaded with high-burnup metal fuel adopts uranium-zirconium alloy fuel, and many problems for metal fuel operation in the reactor have not been solved, such as fuel swelling caused by fission products, fuel-cladding mechanical interaction (FCMI), and even pellet cracking. They are often the direct cause of the fuel system failure. These negative effects not only reduce the efficiency of reactor operation, but also increase the potential safety hazards of reactor. How to fundamentally eliminate swelling and cracking of pellets under service conditions and the FCMI caused therefrom has always been the focus of research and development personnel. While one of the main factors causing fuel swelling is the presence of fission gases. Since the fission gas atoms are insoluble in the metal fuel matrix, they can move freely in the matrix, including a series of behaviors such as migration, nucleation and formation of bubbles. The free migration of fission gas atoms and bubbles in the crystal often causes them to stay at the crystal boundary by pinning, so that more and more bubbles stay at the crystal boundary, thus interconnecting the bubbles, and finally releasing the fission gas into the fuel gas chamber through the connecting channels. However, bubbles and fission gas atoms also interact with defects in the crystal and are pinned by defects such as dislocations, clusters, nuclear transmutation impurities, which deprives of the migration ability of bubbles and traps them in the crystal, resulting in almost irreversible swelling of the fuel.

In order to cope with the swelling problem caused by fission gas, some pores are reserved at the stage of fuel manufacturing to contain the fission gas, and centre pores are reserved in the fuel to discharge the fission gas. However, with the increase of burnup, the pores are filled by fission products, and the pellets will gradually swell, resulting in the gradually shrinking and eventually disappearing of the central pores. The fission gas will be re-trapped inside the fuel, resulting in the continued swelling of fuel and very significant FCMI. Therefore, the high-burnup (25%-30%) metal fuel is designed to reduce the effective density to 55%, so that the fuel has a longer burnup section to withstand the conversion from open pores to closed pores. However, these measures can only alleviate the swelling caused by fission gas and prolong the burn-up, but cannot fundamentally solve the problem.

### SUMMARY

In light of the above-mentioned shortcomings in prior art, the disclosure provides a high-burnup fast reactor metal fuel that can be used in high-burnup traveling wave reactors or other fast reactors to improve the uranium utilization, almost fundamentally avoid FCMI caused by fuel swelling, reduce the fuel failure rate and extend the service life of fuel.

To achieve the above purpose, the technical scheme of the disclosure is as follows:

A high-burnup fast reactor metal fuel, wherein the reactor has a typical pool-type fast reactor core and is loaded with metal fuel made of natural uranium alloy U-50Zr.

Further, the reactor core operates in such a way that after the first-loaded reactor core has been operating for a certain period of time under normal conditions, when equivalent fission gas is accumulated, the temperature rise is controlled manually to cause phase transition of the fuel and keep it in the γ phase for a period of time, which effectively accelerates the release of fission gas; after the fission gas is released, cool down the fuel by temperature control to cause further phase transition, and then return to the δ-phase for operation under normal conditions; the process of phase transition during temperature rise is also the driving force to promote the rapid movement and release of fission gas; repeat the above actions for release of fission gas after operating for a period of time in the δ-phase and cycle on and on.

Further, the control range of fuel centerline temperature is 550-630° C.

Further, the fuel temperature is controlled within an ideal phase transition temperature range through the reactor power regulation to trigger large release of fission gas.

Further, the pulse-type phenomenon of repeatedly accelerating the release of fission gas by repeatedly regulating the temperature.

The disclosure has beneficial effects that:

1. Manually control the temperature to realize phase transition, increase burnup, and extend the service life of fuel and the refueling cycle;

2. Increase the fuel burnup to increase uranium utilization and reduce the volume of nuclear waste to be disposed and pressure of toxicity per unit volume;

3. Extend the fuel life cycle to reduce nuclear power costs and improve the economy of nuclear energy;

4. Effectively carry out the timely release of fission gas, thus reducing the fuel-cladding mechanical interaction caused by swelling, and increasing the safety.

### BRIEF DESCRIPTION OF DRAWINGS

FIG. 1 is the U—Zr phase diagram (as a reference basis for innovation points);

FIG. 2 is a schematic diagram of fission gas release during the whole process of reactor core operation mode in the disclosure;

FIG. 3 is a schematic diagram of the fission gas release in the disclosure as a function of fuel burnup;

### DETAILED DESCRIPTION OF THE PREFERRED EMBODIMENTS

In order to make the contents of the disclosure easier to be clearly understood, technical schemes in embodiments of the disclosure will be described clearly and completely in conjunction with drawings in embodiments of the disclosure.

The drawings show a high-burnup fast reactor metal fuel, wherein the reactor has a typical pool-type fast reactor core and is loaded with metal fuel made of natural uranium alloy U-50Zr.

The operation mode of the reactor core is as follows: After the first-loaded reactor core runs for a certain time under normal conditions, when a certain amount of fission gas is accumulated, the temperature rise is controlled manually to cause phase transition of the fuel and keep it in the γ phase for a period of time, which effectively accelerates the release of fission gas; after the fission gas is released, manually cool it down to cause phase transition, and then return to the δ-phase for normal operation; the process of phase transition during cooling-down is also the driving force to promote the rapid movement and release of fission gas, and the phase transition can effectively eliminate the accumulated irradiation defects; repeat the above actions for release of fission gas after operating for a period of time in the δ-phase and cycle on and on.

The range of fuel core temperature is 550-630° C.

The core temperature of metal fuel is controlled within an ideal phase transition temperature range through the reactor power regulation to trigger large release of fission gas.

The pulse-type phenomenon of repeatedly accelerating the release of fission gas by repeatedly regulating the temperature.

The fuel is U-50% Zr alloy, and due to the extremely low neutron absorption cross section of Zr, the self-breeding of fast reactors loaded with high-burnup metal fuel can be realized even at such a low proportion of uranium. Due to the excellent irradiation and corrosion resistance of Zr, the high-Zr fuel itself has a lower swelling rate than the general fuel. In addition, due to the excellent mechanical properties of Zr, the mechanical properties of fuel are also quite good.

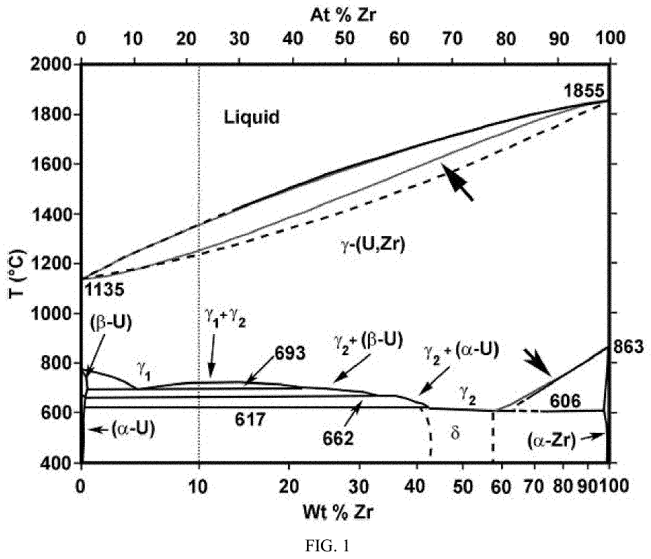

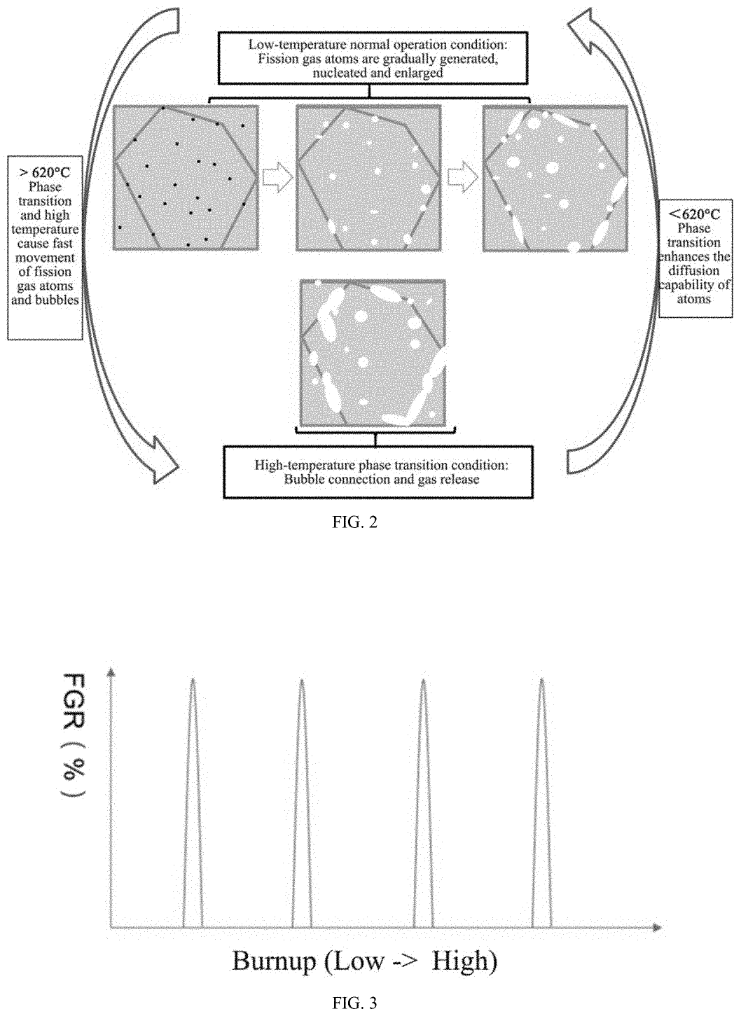

The release of fission gas is dependent on the migration of fission gas atoms and bubbles, and the high migration rate can accelerate the release of fission gas and reduce the swelling of fuel. However, the migration rate of fission gas is not only related to temperature, but also affected by irradiation, defects and the movement of fuel metal matrix atoms. During the phase transition, the fission gas migration can be promoted due to violent diffusion and migration of the atomic system. The reason why high-Zr alloy U-50% Zr is selected as the fuel is that, according to the U—Zr phase diagram shown in FIG. 1, the U—Zr alloy can change from δ to γ phase at 620° C. in this ratio, and the spinodal decomposition can occur at 550° C. in the chemical environment with fission gas and defects. In this ratio, there are only two phases in U—Zr alloy.

At higher temperatures, the migration rate of fission gases is higher, which can promote the movement and release of bubbles. The short-range movement of atoms can exacerbate the movement of fission gas atoms and bubbles when phase transitions occur. After the phase transition to γ phase, the migration rate of bubbles and fission gas atoms in the γ phase is also relatively high, and this can further promote the release of fission gas. Therefore, the unique phase transition of high-Zr U—Zr alloy at a certain temperature can be realized by manually controlling the temperature rise. The high randomness and rapid movement of atoms in the phase change process can be utilized in combination with high temperature to accelerate the migration and release of bubbles, so as to reduce the FCMI problem caused by the swelling of fission gas. After the fission gas is released, the temperature will be reduced, and the fuel phase will be converted into δ phase. This phase transition can remove the defects introduced by irradiation in the crystal, so that the fuel defect level will return to the initial level of the fuel, and continue the operation under normal conditions. The phase transition process in this step can also accelerate the migration of fission gas and promote the release.

After operating under normal conditions for a certain period of time, the natural uranium alloy U-50Zr realizes temperature rise control by power regulation. In case of ULOF (unprotected loss of flow) accident, the reactor core loaded with metal fuel will not have sodium boiling, because the negative feedback mechanism of the metal fuel itself makes its Doppler effect small. The ULOF test at 100% power without emergency shutdown on EBRII (experimental breeder fast reactor II) demonstrated that the reactor core loaded with metal fuel was automatically shut down without emergency shutdown measures and sodium was not boiling. In the ULOF test, the fuel temperature can reach 0.5-0.6Tm (Tm>1400K, representing the melting point of the fuel) of U-50Zr fuel, which is sufficient to cause phase transition from δ to γ phase. Therefore, the fuel temperature control can be realized through power regulation under the premise of safe operation, so as to promote periodic release of fission gas and periodic elimination of defects.

The above are only preferred embodiments of the disclosure and are not intended to limit the disclosure. Any modifications, equivalents, improvements made within the spirit and principles of the disclosure shall fall within the scope of protection of the disclosure.

1. A high-burnup fast reactor metal fuel, characterized in that: the reactor core is loaded with metal fuel made of natural uranium alloy U-50Zr.

2. The high-burnup fast reactor metal fuel of claim 1, characterized in that:
The operation mode of the reactor core is as follows: After the first-loaded reactor core runs for a certain time under normal conditions, when a certain amount of fission gas is accumulated, the temperature rise is controlled manually to cause phase transition of the fuel and keep it in the γ phase for a period of time, which effectively accelerates the release of fission gas;
After the fission gas is released, manually cool it down to cause phase transition, and then return to the δ-phase for normal operation; the process of phase transition during cooling-down is also the driving force to promote the rapid movement and release of fission gas, and the phase transition can effectively eliminate the accumulated irradiation defects;
Repeat the above actions for release of fission gas after operating for a period of time in the δ-phase and cycle on and on.

3. The high-burnup fast reactor metal fuel of claim 2, characterized in that: the control temperature range is 550-630° C.

4. The high-burnup fast reactor metal fuel of claim 2, characterized in that: the fuel temperature is controlled within an ideal temperature range through operating power regulation, so as to allow response to the power of fast reactor metal fuel and controlled release of gas fission products.

5. The high-burnup fast reactor metal fuel of claim 2, characterized in that: the pulse-type phenomenon of repeatedly accelerating the release of fission gas by repeatedly regulating the temperature.
